(19) United States
(12) Patent Application Publication
(10) Pub. No.: US 2008/0057377 A1
(43) Pub. Date: Mar. 6, 2008

(54) UNIFORM FLOW CHANNEL BOARD FOR FUEL CELL

(76) Inventors: TSANG-MING CHANG, Taipei (TW); Chih-Jung Kao, Taipei (TW); Chien-An Chen, Kaohsiung (TW); Wen Jui Chuang, Kaohsiung (TW)

Correspondence Address: G. LINK CO., LTD., 3550 BELL ROAD, MINOOKA, IL, 60447, US

(21) Appl. No.: 11/848,004

(22) Filed: Aug. 30, 2007

(30) Foreign Application Priority Data
Sep. 1, 2006 (CN) 20062013959.1

(51) Int. Cl. H01M 2/14

(52) U.S. Cl. 429/39

(57) ABSTRACT

The present invention discloses an uniform flow channel board for fuel cell, which at least comprises a fuel inlet for introducing fuel, and a plurality of channels connected to the fuel inlet. For the uniform flow channel board according to the present invention, the flowing cross-sectional areas of these channels are not equal to each other, and would have about 10%˜30% difference after calculation for determination of uniformity. The flowing cross-section means the size of cross-section for the fuel flowing through the channel.

### FIELD OF THE INVENTION

The present invention relates to a channel board, and more specifically to an uniform flow channel board for fuel cell.

### BACKGROUND OF THE INVENTION

The fuel cell (FC) is a power generation device by directly converting chemical energy into electrical energy. Comparing to the conventional power generation, the fuel cell is provided with advantages of low pollution, low noise, high energy density, and higher energy conversion rate, and becomes an electricity source of much development potential. Due to the above-mentioned advantages, the present invention is provided with very widely application range, such as portable electronic device, home-based power generation, traffic vehicles, and aerospace industry.

The operation theory of fuel cell would be somewhat different according to the types. With the example of Direct Methanol Fuel Cell (DMFC), when the methanol solution is proceeding oxidation in the anode catalyst layer, it would generate hydrogen ions, electrons, and carbon dioxide, in which the hydrogen ions would be conveyed to the cathode through electrolyte, and the electrons would be conveyed to the loading side from the external circuit and to the cathode; in the meantime, the oxygen supplied to the cathode end would have reduction reaction with hydrogen ions and electrons in the cathode catalyst layer, and generate water.

In order to uniformly introduce the fuel into the membrane electrode assembly in the fuel cell, it still relies on the design of internal channel structure for channel board. In the conventional cathode channel board structure, the structure types could be Serpentine Flow Field (SFF), Interdigitated Flow Field (IFF), Grid Flow Field (GFF), and Channel Flow Field (CFF), in which the CFF has inferior effect though, it has more widely application due to simple structure and lowest cost.

Referring to FIG. 1, FIG. 1 is a structural diagram of the conventional channel board. As shown in FIG. 1, the conventional channel board 10 comprises at least the fuel inlets 12a, 12b for introducing fuel, a plurality of channels 10a˜10d connected to the fuel inlets 12a, 12b, and these channels 10a˜10d are parallel to each other.

However, because the cross-sectional areas of channels 10a˜10d are all the same, the channels 10a, 10d nearest to the fuel inlets 12a, 12b would have less actual flow-in fuel volume than the channels 10b, 10c in the middle (or not adjacent to the fuel inlets 12a, 12b), and further cause the non-uniformity of fuel volume distributed in each channel. Due to this effect, the fuel using the conventional channel board 10 could not provide an uniform reaction rate, which could cause the degradation of cell performance, and relatively reduce the life span.

### SUMMARY OF THE INVENTION

The major object of the present invention is to provide an uniform flow channel board for fuel cell, which could appropriately arrange the cross-sectional area for each channel, so that each channel could have more uniform fuel flow actually, and further improve the cell performance and increase the life span.

Based on the object, the present invention provides an uniform flow channel board for fuel cell, which at least comprises a fuel inlet for introducing fuel, a plurality of channels connected to the fuel inlet, in which these channels are apart from each other. In the uniform flow channel board according to the present invention, the flowing cross-sectional areas of these channels are not equal to each other, and would have about 10%˜30% difference after calculation for determination of uniformity. The flowing cross-sectional area means the size of cross-sectional area of the channel passing through the fuel.

### BRIEF DESCRIPTION OF THE DRAWINGS

The present invention would be detailed described in the following to make the skilled in the art understand the object, features and effects of the present invention through the following embodiments and the attached figures, wherein:

FIG. 1 is a structural diagram of a conventional channel board; and

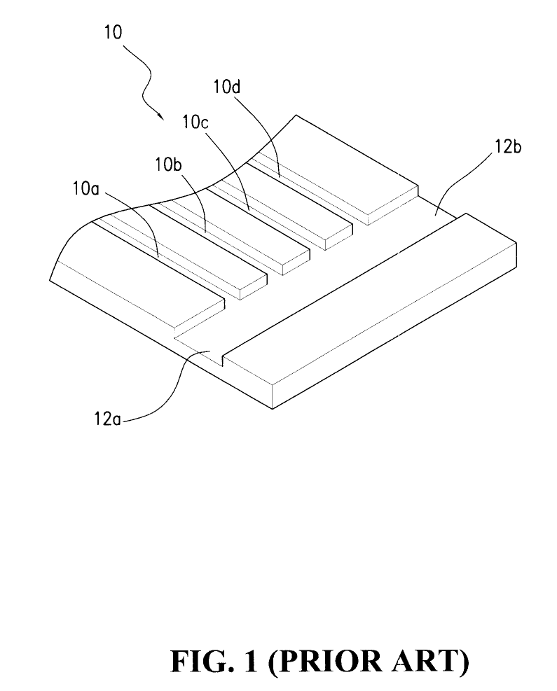

FIG. 2 is a structural diagram of an uniform flow channel board for fuel cell according to the present invention.

### DETAILED DESCRIPTION OF THE INVENTION

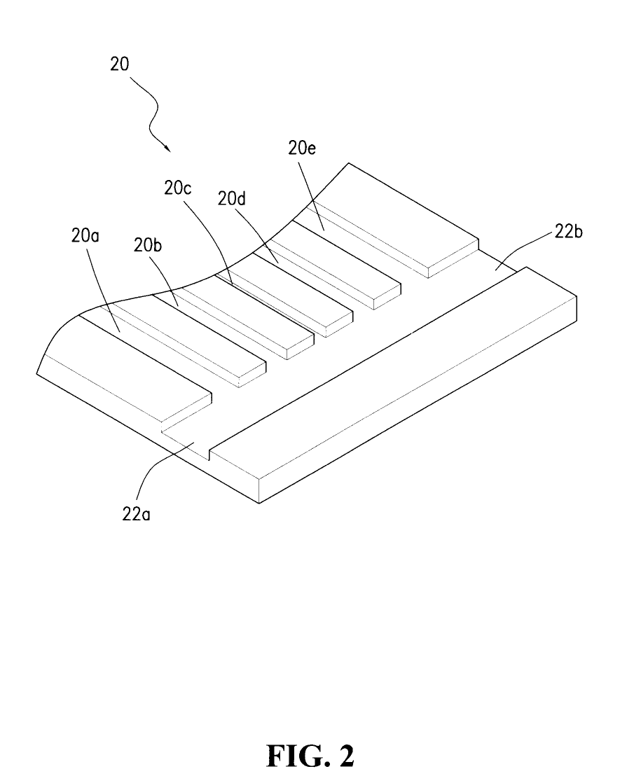

Referring to FIG. 2, it shows a structural diagram of uniform flow channel board for fuel cell according to the present invention. As shown in FIG. 2, the uniform flow channel board 20 for fuel cell according to the present invention also at least comprises the fuel inlets 12a, 12b for introducing fuel, a plurality of channels 20a˜20e connected to the fuel inlets 12a, 12b, in which these channels 20a˜20e are apart from each other, for example, the channels 20a˜20e could be configured parallel to each other. However, the present invention is not limited to the channels in parallel configuration.

In order to reasonably distribute the actual flowing fuel volume for each channel, in the channel board 20 according to the present invention, the flowing cross-sectional areas of the channels 20a˜20e are not equal to each other, and the flowing cross-sectional area means the size of cross-sectional area of the channel passing through the fuel.

More specifically, in order to design the channels 20a˜20e with non-uniform flowing cross-sectional areas, there are approximately three design rules: 1. the flowing cross-sectional areas for the channels 20a˜20e would have 10%˜30% difference; 2. In the channels 20a˜20e, the channels 20a or 20e nearby the fuel inlets 12a or 12b would have the flowing cross-sectional area larger than that of the channel 20c not adjacent to the fuel inlets 12a or 12b; and, 3. In the channels 20a˜20e as shown in FIG. 2, the flowing cross-sectional areas from the channel 20a or 20e nearby the fuel inlets 12a or 12b to the channel 20c in the middle would be sequentially reduced.

The cross-sectional shapes for the channels 20a˜20e could be U-type section, V-type section or other irregular sections. The material for the channels 20a˜20e could be graphite, aluminum or stainless steel; or, the material for the channels 20a˜20e could employ the material of engineering plastics compatible with methanol or formic acid and with anti-acid/anti-erosion properties.

The feature and spirit of the present utility model have been described in details with the preferred embodiments as above, and these disclosed the preferred embodiments are not used to limit the scope of the present utility model; on the contrary, the object is to cover various changes and equivalent arrangements in the scope of the attached claims of the present utility model.

What is claimed is:

1. An uniform flow channel board for fuel cell, which comprises:
an fuel inlet for introducing fuel, a plurality of channels connected to the fuel inlet, and the channels are apart from each other, which is characterized in that the flowing cross-sectional areas of the channels are not equal to each other, wherein the flowing cross-sectional area means the size of cross-sectional area of the channel passing through the fuel.

2. The uniform flow channel board for fuel cell according to claim 1, wherein the flowing cross-sectional areas of the channels have 10%˜30°% difference.

3. The uniform flow channel board for fuel cell according to claim 1, wherein, for the channels, the channels nearby the fuel inlet has the flowing cross-sectional area larger than that of the channel not adjacent to the fuel inlet.

4. The uniform flow channel board for fuel cell according to claim 1, wherein, for the channels, the flowing cross-sectional areas from the channel nearby the fuel inlet to the channel in the middle would be sequentially reduced.

5. The uniform flow channel board for fuel cell according to claim 1, wherein, the cross-sectional shape of the channels could be U-type section, V-type section, or other irregular sections.

6. The uniform flow channel board for fuel cell according to claim 1, wherein the material of the channels could be graphite, aluminum or stainless steel.

7. The uniform flow channel board for fuel cell according to claim 1, wherein the material of the channels could be engineering plastics compatible with methanol or formic acid with anti-acid/anti-erosion properties.
